(19) United States
(12) Patent Application Publication
(10) Pub. No.: US 2007/0109573 A1
(43) Pub. Date: May 17, 2007

(54) Image forming apparatus and method

(75) Inventor: Masatsugu Hirayama, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/271,902

(22) Filed: Nov. 14, 2005

(51) Int. Cl. G06F 3/12

(52) U.S. Cl. 358/1.13

(57) ABSTRACT

A method and apparatus of printing a document in a twin color copy mode of an image forming apparatus. A first color and a second color are selected in the twin color copy mode of the image forming apparatus. The document to be printed is scanned, and an automatic color selection (ACS) unit determines whether or not the scanned document is a color document or a B/W document. Based on the determination by the ACS unit, the document is printed as either a B/W document using black processing or as a color document using color processing.

### FIELD OF THE INVENTION

The present invention relates generally to a printer or to a multi-function peripheral (MFP) and a method for printing a document, more particularly, to an apparatus and method for using an automatic color selection feature of a printer or MFP to utilize only black processing under certain circumstances.

### BACKGROUND OF THE INVENTION

In a conventional printer or copier or MFP (hereinafter collectively referred to as “printer”), a user can print an original document in a variety of different modes. One such mode is Automatic Color Selection mode (ACS), where the printer determines whether or not the original document is a color document or a black-and-white (B/W) document, and prints the document according to that determination.

The determination of whether a document is a color document or a B/W document is performed by an ACS circuit, by utilizing image processing techniques known to those skilled in the art. Typically, when a document is scanned by a scanner, RGB (red/green/blue) data is obtained for each pixel position (no black, or K data, is obtained). If the R, G and B values are equal for a pixel position, the ACS circuit determines that the corresponding pixel is black. For example, assuming that the R, G and B values can take on an integer value between 0 and 255 (2⁸−1), if each of the R, G and B values equaled 255, then the pixel would be determined by the ACS circuit to be a black pixel of the highest density (the darkest possible black pixel). Similarly, if each of the R, G and B values equaled 128, then the pixel would be determined by the ACS circuit to be a black pixel of average density (midway between the darkest possible black pixel and the lightest possible black pixel). In contrast, if the R, G and B values corresponding to a pixel position are sufficiently different from each other, then the ACS circuit determines that the pixel is a color pixel (e.g., is not a black pixel).

If the number of pixels in the document determined by the ACS circuit to be color pixels exceeds a predetermined threshold, then the document is determined by the ACS circuit to be a color document; otherwise the document is deemed to be a B/W document. Given the document type determination as made by the ACS circuit, the document is printed accordingly as either a color document (using one or more of R, G and B toner or ink cartridges) or a B/W document (using only a black toner or ink cartridge).

Another possible copy mode for a conventional printer is a Twin Copy mode, which is separate and distinct from the ACS mode. The Twin Copy mode may also be referred to as a Two Color-Copy mode. When a user selects the Twin Copy mode on a printer, e.g., pressing a particular button on the printer or through a selection on a display panel of the printer, the user then selects a copy color for the black areas on the original, and the user also selects a copy color for the non-black color areas on the original. For example, the user may select “Black” as the copy color for the black areas on the original, and the user may select “Red” or “Green” or “Blue”, or “Yellow” or “Magenta” or “Cyan”, for example, as the copy color for the non-black color areas on the original. Alternatively, the user may select two different non-black colors (e.g., Yellow and Green), or the user may select the same color (either black or non-black).

Also, the user may select a non-black color for copying the black areas on the original, and a black color for copying the non-black areas on the original, if desired. After these selections have been made by the user, the user presses the “Start” button on the printer, and the Twin Copy mode begins.

There exists a desire to provide a printer that provides an efficient utilization of printer resources when printing documents.

### SUMMARY OF THE INVENTION

According to an aspect of the invention, a method of printing a document in a twin color copy mode of an image forming apparatus includes receiving an indication specifying a first color and a second color for the twin color copy mode. The method also includes scanning a document to obtain image data. The method further includes determining, based on the image data, whether or not the scanned document is a color document or a B/W document. The method still further includes using the determination of the determination step, printing the document as a B/W document using black processing or as a color document using color processing.

According to another aspect of the invention, an image forming apparatus for printing a document includes a receiving unit configured to receive a selection that species a first color and a second color for a twin color copy mode. The image forming apparatus also includes a scanner configured to scan a document to obtain image data. The image forming apparatus further includes an automatic color selection unit configured to determine, based on the image data, whether or not the input image is a color image or a B/W image. The image forming apparatus still further includes a printer configured to print the document based on the input image provide by the scanner. The image forming apparatus also includes a processor coupled to the receive the user selection from the input unit and the determination output by the automatic color selection unit, the processor configured to instruct the printer to print the document as either a B/W document using black processing or as a color document using color processing.

According to yet another aspect of the invention, a method of printing a document using a multi-function peripheral (MFP) includes providing, on a display portion of the MFP, a capability of selecting one of an automatic color selection (ACS) mode, a twin color copy mode, and a twin color copy with ACS mode. The method also includes performing a printing operation on the document based on a selection of one of the automatic color selection (ACS) mode, the twin color copy mode, and the twin color copy with ACS mode.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram showing print components used by a conventional printer;

FIG. 2 is a block diagram showing print components used by a printer according to a first embodiment of the invention;

FIG. 3 is a table showing various possible color selections for first and second colors in a Twin Color Copy mode for a conventional printer and for a printer according to the first embodiment.

### DETAILED DESCRIPTION OF THE PREFERRED EMBODIMENTS

An aspect of the present invention provides for using automatic color selection (ACS) information when a Twin Color Copy mode is selected for a printer, to efficiently use printer resources.

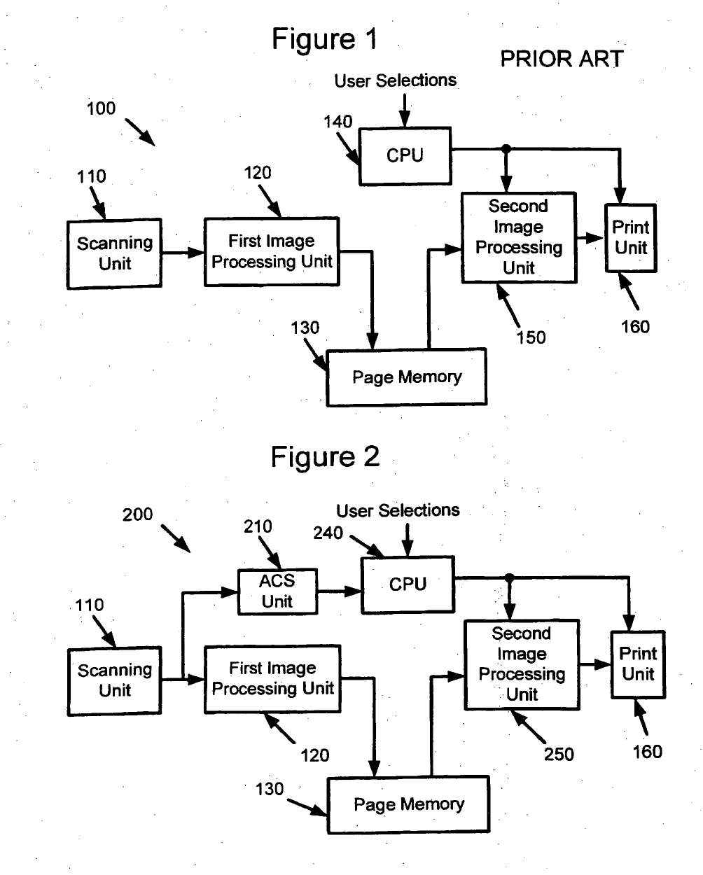

Before describing the first embodiment of the invention, a brief description will be made for a conventional printer carrying out Twin Color Copy Mode printing, as shown in FIG. 1. Printer 100 includes an original scanning unit 110 that scans an original, and which outputs R, G and B (RGB) data for each scanned pixel location of the original, in a manner known to those skilled in the art. The R, G and B data is provided to a first image processing unit 120, which performs color conversion (e.g., RGB→CMY), filtering, etc., in a manner known to those skilled in the art, and provides first image processed data to a page memory 130.

The page memory 130 temporarily stores the first image processed data output by the first image processing unit in units of a page, in a manner known to those skilled in the art. The page memory 130 may be implemented as a random access memory (RAM) or flash memory, for example.

A CPU 140 receives information related to a user's selection of operation mode for the printer 100, and, based on the user's selection, a second image processing unit 150 performs image processing on the first image processed data retrieved from the page memory 130. For example, if the user has selected the Twin Color Copy mode, the CPU 140 will instruct the second image processing unit 150 to perform image processing on the first image processed data retrieved from the page memory 130, in accordance with the two colors selected by the user in the Twin Color Copy mode. Types of image processing performed by the second image processing unit 150 include: generating K data (e.g., CMY→CMYK), gamma correction, and/or halftone processing.

The second image processed data output by the second image processing unit 150 is provided to a print unit 160, which prints a document, under control of the CPU 140, in accordance with the second image processed data.

In a case where a document to be printed is a B/W document, print resources (such as cyan, magenta and/or yellow toner) will be wasted if the user selects a color copy mode, such as a Twin Color Copy mode in which at least one of the selected colors is black. An aspect of the present invention provides a mechanism to mitigate the wasting of printer resources.

A first embodiment of the invention will be described below with reference to FIG. 2. The same components as shown in FIG. 1 are given the same reference numerals in FIG. 2. Printer 200 includes an original scanning unit 110 that scans an original, and which outputs RGB data for each scanned pixel location of the original. The RGB data is provided to a first image processing unit 120, which performs color conversion (e.g., RGB→CMY), filtering, etc., and provides first image processed data to a page memory 130. The page memory 130 temporarily stores the first image processed data output by the first image processing unit 120.

Also, as seen in FIG. 2, an automatic color selection (ACS) unit 210 receives the RGB data output by the first scanning unit 110. The ACS unit 210 determines whether or not the scanned original is in B/W or color. By way of example and not by way of limitation, one way of making this determination is described below. For the RGB data output by the first scanning unit 110, each of the pixels that satisfies the following formula is counted as a color pixel:
|R-G |>TH1, or |G-B|>TH2, or |B-R|>TH3.

If none of the above equations are met for a particular pixel, then the pixel is determined by the ACS unit 210 to be a B/W pixel. Once all of the pixels of the original are analyzed in the manner described above, then the ACS unit 210 determines whether or not the original is a color document or a B/W document, by the following formula:

If total number of color pixels >THC, then the document is a color document; otherwise the document is a B/W document.

In the above formulas, TH1, TH2, TH3 may be predetermined integer values that can be readily set by one skilled in the art (such as by using experimental data and/or test data), and THC may also be a predetermined integer value that can be readily set by one skilled in the art (such as by using experimental data and/or test data).

By way of example and not by way of limitation, assume that the scanned document is scanned into 2048 pixel positions. In this example, THC is 2048/128 (=0.78%)=16; and thus if there are 16 or more color pixels, as determined by the ACS unit, in the scanned document, the document is considered to be a color document. Otherwise, the document is considered to be a B/W document. The value THC is typically set to a value of between 0.1% and 1%.

The ACS unit may perform pixel discrimination by the following process. For color pixel counting, each pixel which satisfies the following formula in the image data is counted as a color pixel (thereby increasing a color pixel count value cnt by one):
R-G>TH1, or G-B>TH2, or B-R>TH3→cnt++

Once color pixel counting has been performed by the ACS unit, it then performs discrimination of the original (color or B/W). This can be done according to the following formula corresponding to the number of color pixels (cnt++) counted using the above formula, to determine whether the original is a color document or a B/W document.

If cnt>THC→color

Else→B/W

In this case, the total number of color pixels is replaced with the variable count in which the color/B/W discrimination of all pixels in the original has finished.

The color or B/W result output by the ACS unit 210 is provided to a CPU 240, whereby the CPU 240 also receives information related to a user's selection of operation mode for the printer 100. Based on the user selection and under control of the CPU 240, a second image processing unit 250 performs image processing on the first image processed data retrieved from the page memory 130.

The second image processed data output by the second image processing unit 150 is provided to a print unit 160, which prints a document, under control of the CPU 240, in accordance with the second image processed data.

A main difference between the printer 200 according to the first embodiment and shown in FIG. 2, and the conventional printer 100 shown in FIG. 1, is that information from an ACS unit 210 is utilized at least in certain cases when the user has selected the Twin Color Copy mode. The interplay of the ACS unit 210 and the Twin Color Copy mode is described in more detail hereinbelow.

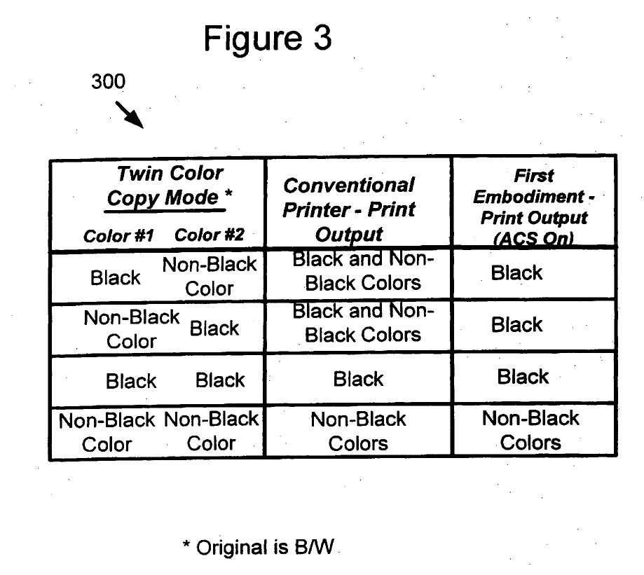

FIG. 3 shows a table 300 depicting the different possible types of print processing that are performed by the printer 200 as shown in FIG. 2, as compared to a conventional printer such as the printer 100 as shown in FIG. 1. Based on the two colors selected by the user in a Twin Color Copy mode, the print output can be different from the output according to the conventional printer.

When the user selects, e.g., via an operation panel on the printer, the Twin Color Copy mode, the user then selects, e.g., via the operation panel, the two colors for the Twin Color Copy mode. In a first case, the user selects Black as the first color for printing the black areas of the original, and the user selects a non-black color, such as Magenta, as the second color for printing the non-black color areas of the original. The conventional printer 100 of FIG. 1 will perform image processing based on these user selections, irrespective as to whether or not the original is B/W or color. For example, if the original is B/W, the conventional printer 100 of FIG. 1 will utilize color ink (e.g., magenta ink) to print portions of the B/W original in color, thereby wasting printer resources.

In contrast, the printer 200 of FIG. 2, according to the first embodiment, will determine that the original is B/W by way of the ACS Unit 210, and that information will be provided to the CPU 240. The CPU 240 will instruct the second image processing unit 250 to perform “black” image processing of the first image processed data obtained from the page memory 140. By way of example, the CMY data obtained from the page memory 140 may be converted to black data by: K=(C+M+Y)/3. The second image processed data output by the second image processing unit 250 will be printed by the printer unit 160, as a B/W printed document, using only K values.

In the second case, as shown in the table 300 of FIG. 3, the user selects a non-black color for the first color in the Twin Color Copy mode, and the user selects black as the second color in the Twin Color Copy mode. The difference between the second case and the first case is that, in the first case, the user has instructed the printer to print the black portions of the original as black and the non-black color portions as the selected non-black color, while in the second case the user has instructed the printer to print the non-black color portions of the original as black and the black portions as the selected non-black color. In either case, the conventional printer 100 of FIG. 1 inefficiently utilizes color toner resources in attempting to print portions of the B/W original in a non-black color, while the printer 200 of the FIG. 2 (according to the first embodiment) prints the document in B/W and thus does not waste color toner resources when printing a B/W original. In printing the document in B/W, the user may be informed accordingly, such as through a displayed message or other indication on the panel of the printer. In this second case (black is the “second” color), an alternative is to utilize the color printing process even with the ACS determination being used.

In a third case, as shown in the table 300 of FIG. 3, the user has selected black as the color for both the first and second colors in the Twin Color Copy mode. In this case, both the conventional printer 100 of FIG. 1 and the printer 200 of FIG. 2 according to the first embodiment process the image data as “black” data (only K values output by the second image processing unit 150/250), and each prints out a B/W document.

In a fourth case, as shown in the table 300 of FIG. 3, the user has selected two non-black colors for the first and second colors in the Twin Color Copy mode. For example, the user selects red as the first color and cyan as the second color. In this case, both the conventional printer 100 of FIG. 1 and the printer 200 of FIG. 2 according to the first embodiment process the image data as “color” data, and print out a color document using the two selected colors. That is, the second image processing unit 150/250 of FIG. 1 and FIG. 2, respectively, uses CMY values for printing. If both designated colors are the same, then only the specified color is used. In the fourth case described above, “K” will not be printed since (Color #1, Color #2)=(Non-Black Color, Non-Black Color) is selected as the two selected colors to copy. Moreover, in the case of Color #1 equals to Color #2 where both colors are non-Black, the operation starts with the specified toner or ink as described (and the print process of only by the specified color). However, in the case of Color #1 does not equal Color #2 and the colors are both Non-Black, the specified two colors for toner are used even if Color #1 is a very small amount and the original is B/W, and the operation of the print process for two color toner is performed.

Thus, for the image forming apparatus according to the first embodiment, when the original is determined to be a B/W document, only when the user has selected two non-black colors in the Twin Color Copy mode does the image forming apparatus attempt to print the document as a color document, while the conventional printer would inefficiently attempt to print portions of the document in color as long as the user has selected at least one non-black color in the Twin Color Copy mode.

Since black processing only requires black toner or black ink, excessive color processing resources including the toner ink are reduced in cases where the original is B/W and the document is to be printed with at least one color being black. In addition, more simplified processing is carried out through black processing including avoiding need for combining colors to get a certain color (e.g., red) and using only K values for printing. In two color copy mode of copying, when black and red are selected, for example, the black area on the original is reproduced with “K” and the area other than black on the original is reproduced with red (Y+M). Since the separation accuracy of black and colors other than black in the original is not perfect, for example, a bright gray part in the original may not be treated as black and some colors may be mixed. That is, although the color selected as “other than black” may be mixed, black is not reproduced by CMYK in the two color copy mode. In the full color mode, the black part of the original is reproduced by the four colors of CMYK.

In a second embodiment, when the user selects the Twin Color Copy mode and when the user has selected the two colors for printing, the printer performs a determination by way of an ACS Unit to check whether or not the document is a color document or a B/W document. If the user has selected at least one black color for printing and if the ACS unit has determined that the document is a B/W document, then a message is displayed on a display portion of the printer (it may also be accompanied by an audible message in an alternative implementation), informing the user that the original is B/W and asking the user if he/she really wants to print the document using a two color printing mode or a standard B/W printing mode. Based on the user's selection, the document is printed either in black only mode, in black and color mode, or in color mode.

Alternatively, the MFP can ask the user to check if the original document is in B/W, and give the user the option again to select the printing mode.

In a third embodiment of the invention, the printer is provided with an “ACS mode” selectable by a user, a “Twin Color Copy mode” selectable by a user, and an “ACS and Twin Color Copy mode” selectable by the user. These modes may either be selectable by way of separate buttons on the printer, or by way of a printer display that allows touch-screen selections made by the user. In the third embodiment, the ACS mode operates as a conventional ACS mode, and the Twin Color Copy mode operates as a conventional Twin Color Copy mode. The ACS and Twin Color Copy mode operates as described with respect to the first embodiment of FIG. 2. That way, a user is provided with a way to select either a conventional Twin Color Copy mode or a different type of Twin Color Copy mode that uses ACS data. Even with the selection of Twin Color Copy mode, the result of the ACS determination can be displayed for the user, further giving the user the choice to confirm/select the printing mode.

The foregoing description of a preferred embodiments of the inventions has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method of printing a document in a twin color copy mode of an image forming apparatus, comprising:
receiving an indication specifying a first color and a second color for the twin color copy mode;
scanning a document to obtain image data;
determining, based on the image data, whether or not the scanned document is a color document or a B/W document;
using the determination of the determination step, printing the document as a B/W document using black processing or as a color document using color processing.

2. The method according to claim 1, wherein the image forming apparatus is one of a printer, a multi-function peripheral, and a copier.

3. The method according to claim 1, wherein, in the printing step, the document is printed as a B/W document when both: a) the scanned document is determined to be a B/W document, and b) at least one of the first and second colors selected is black.

4. The method according to claim 3, further comprising:
if the scanned document is determined to be a B/W document in the determining step, providing a visual indication that the document is to be printed as a B/W document.

5. The method according to claim 3, further comprising:
if the scanned document is determined to be a B/W document in the determining step, providing an indication, by way of a display provided on the image forming apparatus, that the original is a B/W document and requesting confirmation that the document is to be printed as a B/W document.

6. The method according to claim 5, wherein, in the printing step, the document is printed as a color document when both the first and second colors are non-black colors, even if the determination of the determining step is that the scanned document is a B/W document.

7. The method according to claim 1, further comprising, after the scanning step:
performing first image processing on the scanned document, and outputting first image processed data; and
storing the first image processed data in a page memory.

8. The method according to claim 7, further comprising, after the determining step:
performing second image processing on the first image processed data retrieved from the page memory, using the determination of the determining step of whether the scanned document is a color document or a B/W document.

9. The method according to claim 1, wherein the receiving step comprises:
providing a display panel with at least a color copy mode selection region, a B/W copy mode selection region, and a twin color copy mode selection region;
detecting operator selection of one of the color copy mode selection region, the B/W copy mode selection region, and the twin color copy mode selection region.

10. The method according to claim 3, further comprising:
if the scanned document is determined to be a B/W document in the determining step, providing an indication, by way of a display provided on the image forming apparatus, that the original is a B/W document, and allowing a user to modify a print selection previously made for printing the document.

11. An image forming apparatus for printing a document, comprising:
a receiving unit configured to receive a selection that species a first color and a second color for a twin color copy mode;
a scanner configured to scan a document to obtain image data;
an automatic color selection unit configured to determine, based on the image data, whether or not the input image is a color image or a B/W image;
a printer configured to print the document based on the input image provide by the scanner; and
a processor coupled to the receive the user selection from the input unit and the determination output by the automatic color selection unit, the processor configured to instruct the printer to print the document as either a B/W document using black processing or as a color document using color processing.

12. The image forming apparatus according to claim 11, further comprising:
a first image processing unit communicatively coupled to the scanner and configured to perform first image processing on the input image, to obtain first image processed data;
a page memory configured to temporarily store the first image processed data; and
a second image processing unit communicatively coupled to the page memory and the processor, the second image processing unit configured to perform second image processing on the first image processed data based on instructions provided by the processor.

13. The image forming apparatus according to claim 11, wherein the first image processing unit performs RGB conversion of the input image obtained from the scanner.

14. The image forming apparatus according to claim 11, wherein the second image processing unit performs RGB→CMY conversion of the first image processed data obtained from the page memory.

15. The image forming apparatus according to claim 11, wherein processor is configured to instruct the printer to print the document as a B/W document when both: a) the scanned document is determined to be a B/W document, and b) at least one of the first and second colors is black.

16. The image forming apparatus according to claim 11, further comprising:
a display unit configured to provide an indication that the document will be printed as a B/W document.

17. The image forming apparatus according to claim 11, further comprising:
a display unit configured to provide an indication that the document will be printed as a B/W document when the selection received by the receiving unit includes at least one non-black color when the document is B/W, and to request a confirmation that the document is to be printed in B/W.

18. The image forming apparatus according to claim 11, wherein the image forming apparatus is one of a multi-function peripheral, a printer, and a copier.

19. The image forming apparatus according to claim 12, wherein the second image processing unit performs the second image processing on the first image processed data using only K data when at least one of the first and second colors is black in the twin color copy mode.

20. A method of printing a document using a multi-function peripheral (MFP), comprising:
providing, on a display portion of the MFP, a capability of selecting one of an automatic color selection (ACS) mode, a twin color copy mode, and a twin color copy with ACS mode; and
performing a printing operation on the document based on a selection of one of the automatic color selection (ACS) mode, the twin color copy mode, and the twin color copy with ACS mode.

21. The method according to claim 20, wherein the performing step comprises, when the selection is the twin color copy with ACS mode:
scanning the document to determine if the document is a B/W document or a color document; and
if the document is a B/W document, and if one of the two colors selected in the twin color copy mode is black, printing the document as a B/W document.

22. The method according to claim 20, wherein, when the selection is the twin color copy with ACS mode and when the scanned document is B/W and when one of the two colors selected in the twin color copy mode is black:
providing an indication of the display portion of the MFP that the document is to be printed as a B/W document.

23. The method according to claim 20, wherein, when the selection is the twin color copy with ACS mode and when the scanned document is B/W and when one of the two colors selected in the twin color copy mode is black:
providing a request for verification on the display portion of the MFP that the document to be printed is a B/W document.

24. An image forming apparatus, comprising:
a display portion that provides a capability of selecting one of an automatic color selection (ACS) mode, a twin color copy mode, and a twin color copy with ACS mode; and
a processing portion that performs a printing operation on the document based on a selection of one of the automatic color selection (ACS) mode, the twin color copy mode, and the twin color copy with ACS mode.

25. The image forming apparatus according to claim 24, further comprising:
a scanning portion for scanning the document to determine if the document is a B/W document or a color document,
wherein, when the selection is the twin color copy with ACS mode and if the document is determined by the scanning portion to be a B/W document and if one of the two colors selected in the twin color copy mode is black and the other of the two colors is non-black, the processing portion prints the document as a B/W document.

26. The image forming apparatus according to claim 25, wherein, when the selection is the twin color copy with ACS mode and when the scanned document is B/W and when one of the two colors selected in the twin color copy mode is black,
the display portion of the MFP provides an indication that the document is to be printed as a B/W document.
